(19) United States
(12) Patent Application Publication
(10) Pub. No.: US 2007/0030586 A1
(43) Pub. Date: Feb. 8, 2007

(54) APPARATUS AND METHOD FOR HARD DISK PROTECTION

(75) Inventors: Cheng-Pu Chu, Taipei Shien (TW); Tai-Shing Wan, Tao Yuang Shien (TW); Jung-Wen Chang, Tao Yuan Shien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: QUANTA COMPUTER INC., Tao Yuan Shien (TW)

(21) Appl. No.: 11/382,074

(22) Filed: May 8, 2006

(30) Foreign Application Priority Data
Aug. 8, 2005 (TW) 94126863

(51) Int. Cl. G11B 15/18

(52) U.S. Cl. 360/73.01; 360/71

(57) ABSTRACT

A hard-disk protection apparatus is coupled to a hard disk applied to an electronic apparatus. The hard-disk protection apparatus includes a sensor and a circuit breaking device. The sensor is for sensing an acceleration of the hard disk as the hard disk is moved by an external force. The circuit breaking device determines whether to cut off the power supply from the electronic apparatus to the hard disk according to the magnitude of the acceleration.

This application claims the benefit of Taiwan application Serial No. 94126863, filed Aug. 8, 2005, the subject matter of which is incorporated herein by reference.

### BACKGROUND OF THE INVENTION

1. Field of the Invention

The invention relates in general to an apparatus for hard disk protection, and more particularly to an apparatus and method for protecting the hard disk by cutting off its power supply.

2. Description of the Related Art

In recent years, portable electronic or computer products, including mobile phones, personal digital assistants (PDA), MP3 players, flash disks, notebook computers and digital cameras, become very popular in the markets and have been a favorite equipment for the consumers due to their thinness and smallness. The user can store the pictures or films he/she likes into the hard disk drive (HDD) provided by the portable electronic product as a backup.

In terms of structure, the hard disk includes a magnetic pickup head, a spindle motor, and a platter. The platter includes a number of sectors, and the spindle motor is used to rotate the platter quickly for the magnetic pickup head to read data on the sectors. The hard disk uses a plurality of platters to increase its storage volume and thus the magnetic pickup head has to move rapidly and accurately in order to read the data correctly. Therefore, any external force may cause the magnetic pickup head to make errors in reading data under the high-speed rotation of the platters.

However, the conventional hard disk takes no good protection measures on this issue. When the hard disk in operation is dropped from a high place, the force of the impact will cause a physical and structural damage of the hard disk and ruin the data stored in the hard disk. Therefore, how to protect a dropping hard disk from data damage is an essential subject for industrials.

### SUMMARY OF THE INVENTION

It is therefore an object of the invention to provide an apparatus and method for hard disk protection. When the hard disk is dropped, the power supply to the hard disk can be automatically cut off to prevent the hard disk from losing data.

The invention achieves the above-identified object by providing a hard-disk protection apparatus. The hard-disk protection apparatus is coupled to a hard disk applied to an electronic apparatus. The hard-disk protection apparatus includes a sensor and a circuit breaking device. The sensor is for sensing an acceleration of the hard disk as the hard disk is moved by an external force. The circuit breaking device is coupled to the sensor for determining whether to cut off the power supply from the electronic apparatus to the hard disk according to the magnitude of the acceleration.

The invention achieves the above-identified object by providing a hard-disk protection method applied to an electronic apparatus including a sensor, a circuit breaking device and a hard disk. The method includes sensing an acceleration of the hard disk by using the sensor as the hard disk is moved by an external force; and determining whether to cut off the power supply from the electronic apparatus to the hard disk according to the magnitude of the acceleration by using the circuit breaking device.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a portable electronic apparatus according to a preferred embodiment of the invention.

FIG. 2 is a schematic diagram of the hard disk according to the preferred embodiment of the invention.

FIG. 3 is a schematic diagram of the portable electronic apparatus according to the first embodiment of the invention.

FIG. 4 is a schematic diagram of the hard-disk protection apparatus according to the second embodiment of the invention.

FIG. 5 is a flow chart of the hard-disk protection method according to a preferred embodiment of the invention.

### DETAILED DESCRIPTION OF THE INVENTION

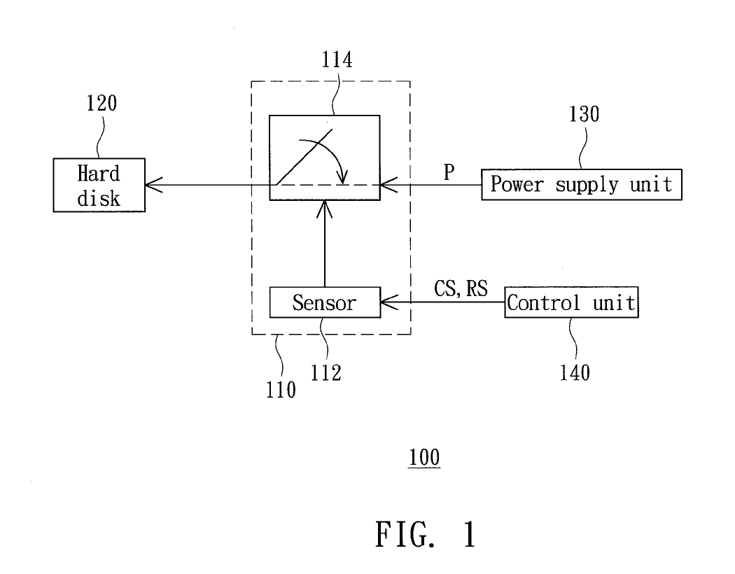

Referring to FIG. 1, a block diagram of a portable electronic apparatus according to a preferred embodiment of the invention is shown. The portable electronic apparatus 100 includes a hard-disk protection apparatus 110, a hard disk 120, a power supply unit 130 and a control unit 140. The hard-disk protection apparatus 110 is coupled to the hard disk 120, the power supply unit 130 and the control unit 140 and is used for detecting the state of the hard disk 120. The hard-disk protection apparatus 110 includes a sensor 112 and a circuit breaking device 114. The sensor 112, for example a MEMS G-Force sensor, is coupled to the circuit breaking device 114 and the control unit 140.

The power supply unit 130 and the sensor 112 are coupled to the hard disk 120 via the circuit breaking device 114, and the control unit 140 is coupled to the sensor 112.

The power supply unit 130 supplies the power P to the hard disk 120 via the circuit breaking device 114. The circuit breaking device 114, for example a switch, is used for cutting off the power supply to the hard disk 120. The effect of stopping the power supply can be achieved as the circuit breaking device 114 (the switch) is open, that is, under a non-conducting state. The control unit 140, for example a micro-processor, is coupled to the hard disk 120 via the sensor 112 and the circuit breaking device 114, and can output information, such as control signals CS and data, to the hard disk 120.

The sensor 112 determines if the circuit breaking device 114 is switched on by sensing the magnitude and direction of the acceleration of the hard disk 120. When the hard disk 120 of the portable electronic apparatus 100 is moved by an external force, the sensor 112 senses the magnitude of the acceleration of the hard disk 120. That is, when the portable electronic apparatus 100 is dropped carelessly, the acceleration of the hard disk 120 will be changed. Therefore, the sensor 112 can sense the variation of the hard-disk acceleration and the control unit 140 compares the acceleration with a predetermined range of acceleration values. When the acceleration of the hard disk 120 lies out of the predetermined range, it means the acceleration of the hard disk 120 is larger than a standard value. Therefore, the circuit breaking device 114 is switched to the non-conducting state to cut off the power supply to the hard disk 120 and stop the data access operation on the hard disk 120, thereby preventing data in the dropping hard disk from being damaged.

After the hard disk 120 is set in a power-off state, the hard disk 120 can receive the power supply again as the control unit 140 generates a reset signal RS or the system power (not shown in the figure) of the portable electronic apparatus 100 is restarted. That is, under one of the above-mentioned conditions is satisfied, and the security of the hard disk 120 is ensured, i.e. the acceleration of the hard disk 120 lies in the above-mentioned predetermined range, the hard disk 120 will be actuated again.

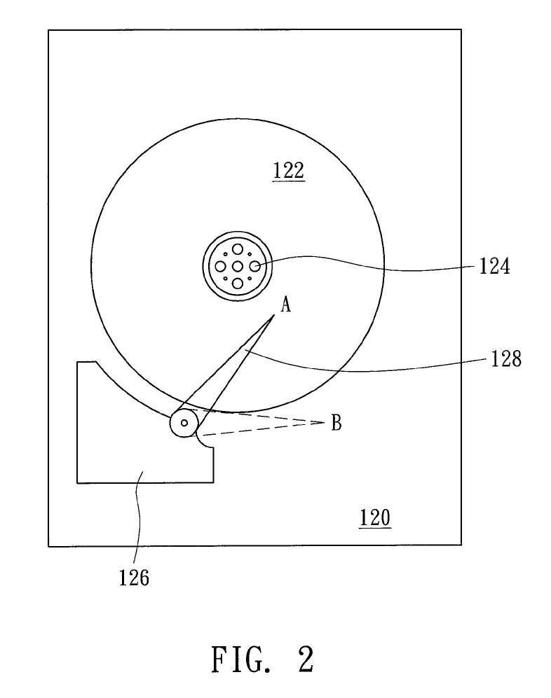

Referring to FIG. 2, a schematic diagram of the hard disk 120 according to the preferred embodiment of the invention is shown. The hard disk 120 includes a platter 122, a spindle motor 124, an actuator 126 and a magnetic pickup head 128. The spindle motor 124 is used for rotating the platter 122 and the actuator 126 is used for driving the magnetic pickup head 128 to move in the region between the internal and the external diameters of the platter 122 in order to read data in different sectors (not shown in the figure) of the platter 122.

When the circuit breaking device 114 cuts off the power supply to the hard disk 120, the magnetic pickup head 128 stops reading and the spindle motor 124 stops rotating. At this time, the magnetic pickup head 128 moves out of the platter 122 by the actuator 126 due to the cut-off in power supply, for example, moves from the position A to B as shown in FIG. 2, to prevent vibration of the magnetic pickup head 128 caused by external forces from damaging the platter 122 in high-speed rotation and causing data lose in the platter 122. When the power is supplied again, the magnetic pickup head 128 returns to the region of the platter 122 from the position B to perform the data access operation.

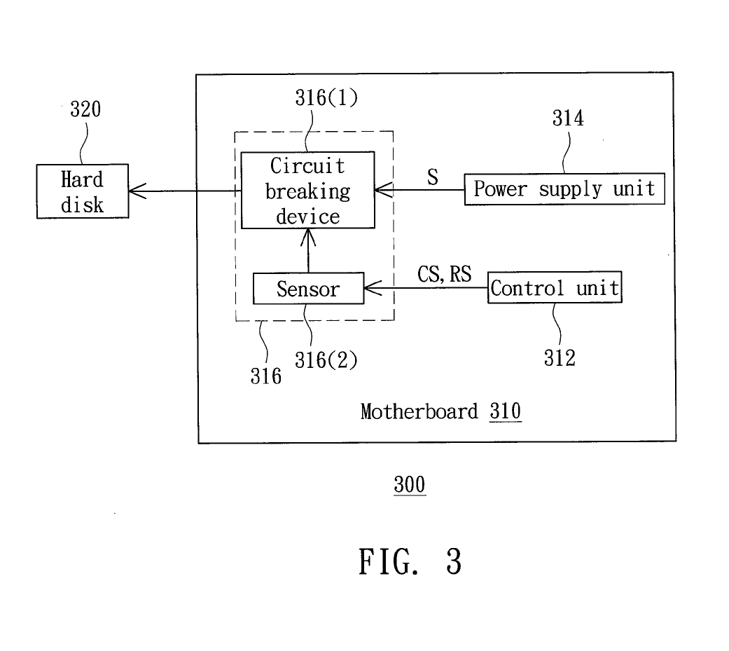

In a first embodiment of the invention, the hard-disk protection apparatus is disposed on a motherboard of the portable electronic apparatus. Referring to FIG. 3, a schematic diagram of the portable electronic apparatus according to the first embodiment of the invention is shown. The portable electronic apparatus 300 includes a motherboard 310 and a hard disk 320, and the hard disk 320 is fixed to the motherboard 310. The motherboard 310 is equipped with a control unit 312, a power supply unit 314 and a hard-disk protection apparatus 316, wherein the hard-disk protection apparatus 316 is coupled to the hard disk 320, the power supply unit 314 and the control unit 312. The hard-disk protection apparatus 316 further includes a circuit breaking device 316(1) and a sensor 316(2). The circuit breaking device 316(1) is coupled to the hard disk 320, the power supply unit 314 and the sensor 316(2) while the sensor 316(2) is coupled to the control unit 312. The control unit 312 controls the hard-disk protection apparatus 316 to compare the acceleration of the hard disk 320 sensed by the sensor 316(2) with a predetermined value. That is, when the sensed acceleration lies out of a predetermined range, the control unit 312 controls the circuit breaking device 316(1) via the sensor 316(2) to stop the power supply unit 314 from supplying the power to the hard disk 320. When the portable electronic apparatus 300 is dropped carelessly, the purpose of cutting off the power supply to the hard disk 320 can be achieved by switching the circuit breaking device 316(2) to the non-conducting state.

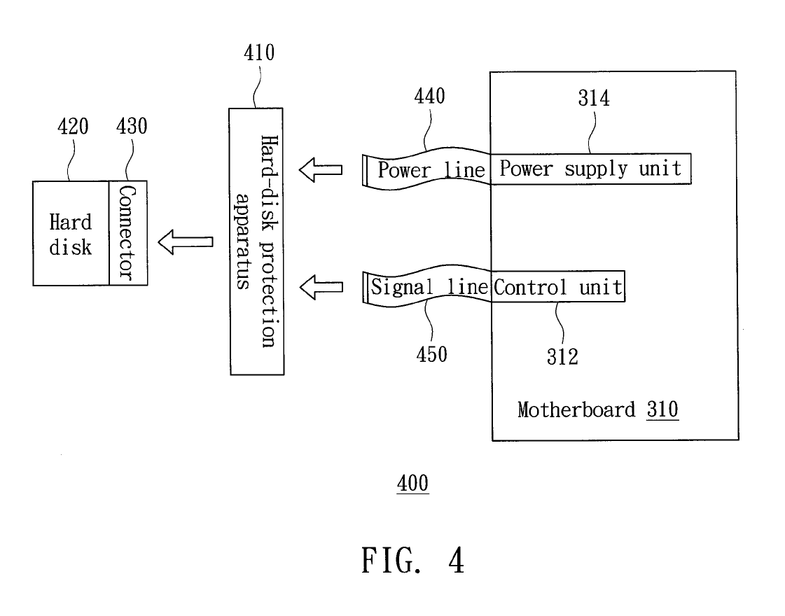

In a second embodiment, the hard-disk protection apparatus is configured as a module. In this way, the hard-disk protection apparatus needs not to be controlled by additional driving circuits or firmware, thereby increasing its elasticity on design. Referring to FIG. 4, a schematic diagram of the hard-disk protection apparatus according to the second embodiment of the invention is shown. The hard-disk protection apparatus is disposed in a portable electronic apparatus, such as a notebook computer 400. The notebook computer 400 includes a hard disk 420, a hard-disk protection apparatus 410, a power line 440, a signal line 450 and a motherboard 310. The hard-disk protection apparatus 410 is coupled to the hard disk 420, the power line 440 and the signal line 450. A control unit 312 and a power supply unit 314 are disposed on the motherboard 310, and the hard disk 420 has a connector 430. The hard-disk protection apparatus 410 in module configuration has one end coupled and fixed to the hard disk 420 via the connecter 430 in order to detect the state of the hard disk 420, and the other end coupled to the power line 440 and the signal line 450. The power line 440 and the signal line 450 are respectively coupled to the power supply unit 314 and the control unit 312. When the hard disk 420 is moved by an external force, and the sensed acceleration of the hard disk 420 lies out of a predetermined range, the hard-disk protection apparatus 410 is switched to a non-conducting state to cut off the power transmission between the hard disk 420 and the power line 440. As shown in the above-mentioned embodiment (FIG. 3), the signal transmission between the control unit 312 and the hard disk 420 can be stopped at the same time.

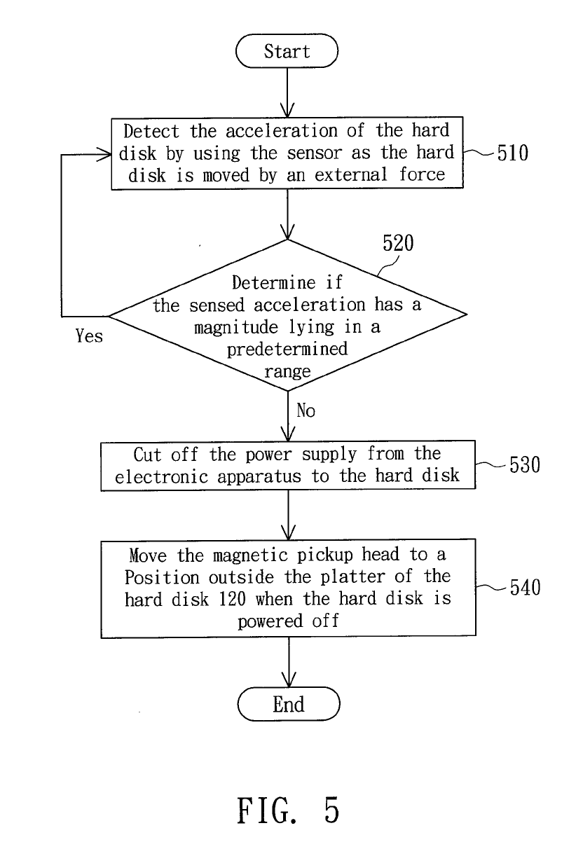

Referring to FIG. 5, a flow chart of the hard-disk protection method according to a preferred embodiment of the invention is shown. The method can be applied to the portable electronic apparatus 100 as shown in FIG. 1, or the electronic apparatus seldom moved, such as a desktop computer. The method starts from the step 510 to detect the acceleration of the hard disk 120 by using the sensor 112 fixed to the hard disk 120 as the hard disk 120 is moved by an external force. Following that, in step 520, determine if the sensed acceleration has a magnitude lying in a predetermined range. If no, continue the step 530 to cut off the power supply from the electronic apparatus 100 to the hard disk 120. Next, in step 540, move the magnetic pickup head 128 to a position out of the platter 122 of the hard disk 120 when the hard disk 120 has no power supply, that is, the hard disk 120 is powered off. In this way, the magnetic pickup head 128 can be prevented from damaging the sectors of the platter 122 and causing data lose.

The sensor for sensing the acceleration of a heavy object (an accelerometer) is a kind of prior art. The design of accelerometer can be achieved according to the Hook's law. For example, the heavy object to be accelerated is attached to one end of a spring structure, and the other end of the spring structure is further fixed. When the object to be accelerated moves, it will elongate the spring and the acceleration of the moving object can be thus calculated by measuring the extension amount of the spring. The extension amount of the spring can be measured by using a capacitor operation principle for instance. That is, the extension distance can be obtained easily by measuring the capacitance of the capacitor.

The apparatus and method for hard disk protection disclosed by the above-mentioned embodiment of the invention uses the sensor to detect the acceleration of the hard disk and cuts off the power supply to the hard disk by a circuit breaking device under a suitable condition. Therefore, the damage of the hard disk can be effectively prevented as the portable electronic apparatus is dropped carelessly.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A hard-disk protection apparatus, coupled to a hard disk, the hard disk applied to an electronic apparatus, the hard-disk protection apparatus comprising:
a sensor, for sensing an acceleration of the hard disk as the hard disk is moved by an external force; and
a circuit breaking device, coupled to the sensor for determining whether to cut off the power supply from the electronic apparatus to the hard disk according to the magnitude of the acceleration.

2. The hard-disk protection apparatus according to claim 1, wherein when the acceleration lies out of a predetermined range, the circuit breaking device cuts off the power supply to the hard disk.

3. The hard-disk protection apparatus according to claim 1, wherein after the circuit breaking device cuts off the power of the hard disk, the electronic apparatus supplies the power to the hard disk again as the circuit breaking device receives a reset signal from the electronic apparatus or the electronic apparatus is restarted.

4. The hard-disk protection apparatus according to claim 1, wherein the electronic apparatus has a motherboard, the hard-disk protection apparatus is disposed on the motherboard, the power supplied by the electronic apparatus is transmitted to the hard disk via the circuit breaking device, and when the circuit breaking device is switched off, the power supply is stopped.

5. The hard-disk protection apparatus according to claim 1, wherein the hard-disk apparatus has a module configuration, the hard disk has a connector, the circuit breaking device has one end coupled to a power line, and the other end coupled to the connector, the power supplied by the electronic apparatus is transmitted to the hard disk via the power line, the circuit breaking device and the connector, and when the circuit breaking device is switched off, the power supply is stopped.

6. A portable electronic apparatus, comprising:
a hard disk;
a power supply unit, for supplying power to the hard disk;
a control unit, for controlling the hard disk;
a hard-disk protection apparatus, coupled to the hard disk, the power supply unit and the control unit, the hard-disk protection apparatus comprising:
a sensor, for sensing an acceleration of the hard disk as the hard disk is moved by an external force; and
a circuit breaking device, coupled to the sensor for determining whether to cut off the power supply from the power supply unit to the hard disk.

7. The portable electronic apparatus according to claim 6, wherein the hard disk comprises a magnetic pickup head, a spindle motor, and a platter, the magnetic pickup head is for reading data stored in the platter, the spindle motor is for rotating the platter, and when the acceleration lies out of a predetermined range, the circuit breaking device cuts off the power supply to the hard disk, stops the operation of the magnetic pickup head and the spindle motor, and moves the magnetic pickup head to a position outside the platter.

8. The portable electronic apparatus according to claim 6, wherein the portable electronic apparatus further comprises a motherboard, the control unit, the power supply unit and the hard-disk protection apparatus are disposed on the motherboard, the hard-disk protection apparatus is controlled by the control unit, the power supplied by the power supply unit is transmitted to the hard disk via the circuit breaking device, and when the circuit breaking device is switched off, the power supply is stopped.

9. The portable electronic apparatus according to claim 6, wherein the hard-disk protection apparatus has a module configuration, the hard disk has a connector, the circuit breaking device has one end coupled to a power line and the other end coupled to the hard disk, the power supplied by the power supply unit is transmitted to the hard disk via the power line, the circuit breaking device and the connector, and when the circuit breaking device is switched off, the power supply is stopped.

10. The portable electronic apparatus according to claim 6, wherein after the circuit breaking device cuts off the power supply to the hard disk, the power supply unit supplies the power to the hard disk again as the circuit breaking device receives a reset signal of the control unit or the electronic apparatus is restarted.

11. A hard-disk protection method, applied to an electronic apparatus comprising a sensor, a circuit breaking device and a hard disk, the method comprising:
sensing an acceleration of the hard disk by using the sensor as the hard disk is moved by an external force; and
determining whether to cut off the power supply from the electronic apparatus to the hard disk according to the magnitude of the acceleration by using the circuit breaking device.

12. The method according to claim 11, further comprising:
determining whether the acceleration lies in a predetermined range; and
cutting off the power supply to the hard disk by using the circuit breaking device if the acceleration lies out of the predetermined range, and supplying power to the hard disk continuously if the acceleration lies in the predetermined range.

13. The method according to claim 11, further comprising:
supplying power to the hard disk again after the circuit breaking device cuts off the power supply to the hard disk if the circuit breaking receives a reset signal of the electronic apparatus or the electronic apparatus is restarted.

14. The method according to claim 11, further comprising:
transmitting the power supplied by the electronic apparatus via the circuit breaking device disposed on a motherboard of the electronic apparatus, and cutting off the power supply by switching off the circuit breaking device.

15. The method according to claim 11, further comprising:
transmitting the power supplied by a power line of the electronic apparatus to the hard disk via the hard-disk protection apparatus of module configuration and cutting off the power supply by switching off the circuit breaking device.
